(19) United States
(12) Patent Application Publication
(10) Pub. No.: US 2002/0080751 A1
(43) Pub. Date: Jun. 27, 2002

(54) SYSTEM AND METHOD FOR ROUTING CALLS IN A WIRELESS COMMUNICATION NETWORK

(76) Inventor: PETER HARTMAIER, WOODINVILLE, WA (US)

Correspondence Address: FULBRIGHT & JAWORSKI L.L.P., 2200 ROSS AVENUE, SUITE 2800, DALLAS, TX, 75201, US

(21) Appl. No.: 09/229,794

(22) Filed: Jan. 13, 1999

(51) Int. Cl. H04Q 7/24

(52) U.S. Cl. 370/338

(57) ABSTRACT

A wireless user makes a call to another member of a closed group of users by dialing a code. The Service Control Point (SCP) looks up the number corresponding to the called party and verifies if the called party's wireless device is powered on. If the called party's wireless is powered on and not busy, the call is completed to the active wireless device. If the wireless device is unreachable, the call will be forwarded to another wireline or wireless device as determined by the SCP in communication with the Home Location Register (HLR).

### BACKGROUND

The prior art discloses a method and apparatus for routing calls in an intelligent wireless network. Prior art systems further provide a method of completing a call more efficiently between different wireless networks, i.e., if a particular wireless device is busy or unavailable, prior art systems will route the call to a voice mailbox, or to another wireless device if call forwarding is enabled. Such a system is disclosed in U.S. Pat. No. 5,815,810, entitled “Method and Apparatus for Improved Call Connectivity in an Intelligent Wireless Network” and issued to Gallant et al. (hereinafter “Gallant”), the disclosure of which is hereby incorporated by reference herein. The prior art systems do not provide efficient call connectivity between wireless and wireline networks.

In prior art systems, calls are routed to wireless devices through Mobile Switching Centers (MSC). The MSCs interact with a Home Location Register (HLR) through a Signaling Transfer Point (STP) to retrieve information about called wireless devices. For example, the MSCs exchange messages with the HLR to determine which destination MSC is actually serving a called wireless device. The HLR sends a routing request to the serving MSC. The destination MSC then returns a geographic routing number known as the Temporary Local Directory Number (TLDN). The call is completed to the serving MSC using the TLDN. If a called user is not available on the wireless device, the call may be routed to voice mail or to another telephone number if call forwarding is available. However, the prior art systems do not disclose rerouting calls to a wireline telephone if the called wireless device is not active on the wireless network. Accordingly, there is a need for a system and method for an enhanced call routing system and method that determines whether a called device is active on the wireless network and that automatically forwards calls to a predesignated wireline telephone when the called device is not registered on the network.

### SUMMARY OF THE INVENTION

These and other objects, features and technical advantages are achieved by a system and method which allow callers to dial a code, alias or shortened telephone number for a called party rather than requiring the caller to enter the full destination telephone number. Furthermore, the present invention routes calls between wireless and wireline networks when required thereby enabling the caller to reach the called party when a called device is not active in a wireless network.

The present invention enables a member of a closed-user group to call another member of the same group by dialing an abbreviated number, such as a four-digit extension. The enhanced abbreviated dialing system of the present invention, first verifies whether a wireless device for the called member is powered on and registered with the network. If the wireless device of the called member is registered, the system will complete the call to the wireless device. If the user is unreachable via the wireless device, then the call is forwarded to a Private Branch Exchange (PBX) number or any other communications device associated with the called subscriber. If there is no answer on the PBX, the caller is prompted to deposit a message in the PBX mailbox or any other mailbox specified in the member profile.

In another embodiment of the present invention, if the wireless device of the user is unreachable, i.e., the wireless device is powered off or is powered on but not registered with the serving network, then a trigger can be placed against that wireless device, and all incoming calls to that particular wireless device are routed to the PBX phone or any other communications device associated with the called subscriber.

In the alternative, the originating trigger may be set if the wireless subscriber is out of his local service area. In this embodiment, all incoming calls to the wireless device are routed to the PBX phone.

In both the alternative embodiments above, the incoming call could be from users in the same group or from users outside the group.

The present invention expands the prior art communication systems by providing abbreviated dialing to wireless and wireline customers. Additionally, the present invention improves on prior art communication systems by forwarding calls from wireless networks to wireline networks. Moreover the system described herein provides advanced capabilities to the customers, such as automated routing and billing functionality, automatic appointment reminders etc. Additionally, the present invention increases the role of the Service Control Point (SCP) in completing a call. In the present invention, the SCP communicates with the Home Location Register (HLR) to determine whether the call is to be routed to the wireless phone or wireline phone of the called party. Once the SCP has determined whether the called party is available on the wireless phone or not, it sends the routing digits of either the wireless phone or the wireline phone to the originating Mobile Switching Center (MSC). The originating MSC then completes the call to the called party.

Accordingly, it is a feature of the present invention to provide a system which enables a subscriber to establish and maintain a list of frequently dialed numbers.

It is another feature of the invention to allow calls to be forwarded from a wireless network to a wireline network so as to form an integrated network.

It is a further feature of the invention to allow calls to be forwarded from a wireline network to a wireless network so as to form an integrated network.

It is yet another feature of the invention to provide abbreviated personal dialing to the integrated wireless and wireline network.

It is still another feature of the invention to facilitate updating of the user profile through a web based graphical user interface.

It is still another feature of the invention to facilitate communication between a SCP and a HLR for efficient routing.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWING

For a more complete understanding of the present invention, and the advantages thereof, reference is now made to the following descriptions taken in conjunction with the accompanying drawing, in which:

FIG. 1 is a block diagram of the system incorporating the present invention when a called wireless device is registered in the wireless network;

FIG. 2 is a block diagram of the system incorporating the present invention when the wireless device is not active on the wireless network;

FIG. 3 is a flowchart illustrating the steps followed in a call completion process of an embodiment of the present invention; and

FIG. 4 is a flowchart illustrating the steps followed in a call forwarding process of an embodiment of the present invention.

### DETAILED DESCRIPTION

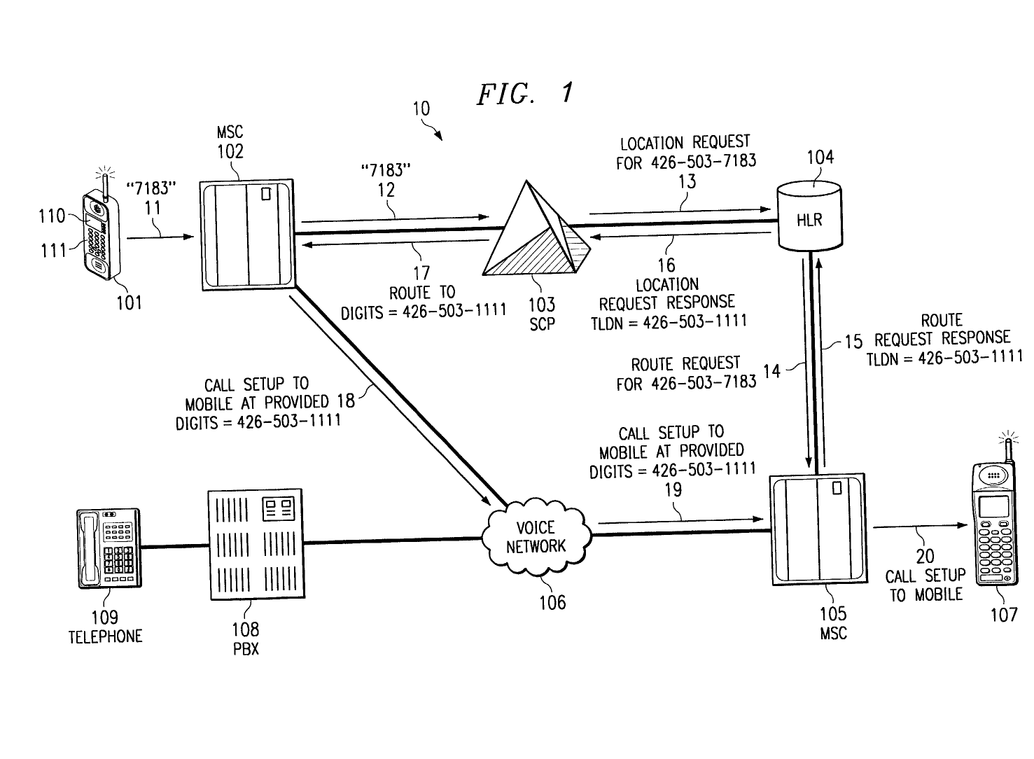

FIG. 1 shows wireless network 10. Wireless device 101 has keypad 111, which allows the user to enter telephone numbers or other information, and display 110, which can be used to display information. A user initiates a call to destination 107 by entering a telephone number on keypad 111. If called wireless device 107 is in the same area code as calling wireless device 101, then only the seven digit NXX-XXXX portion of a telephone number may need to be dialed. However, if the calling party is serviced from an area having a different area code than called wireless device 107, then the entire ten-digit number NPA-NXX-XXXX, including the area code, has to be dialed. Additionally, if the calling party wants to use a particular long distance service provider for a certain call, then he must first dial routing codes used by the long distance service provider otherwise the default “1” may need to be dialed for long distance calls.

As shown in FIG. 1, wireless device 101 communicates with Mobile Switching Center (MSC) 102 and wireless device 107 is in communication with MSC 105. The MSCs are switches that route calls to or from wireless devices within designated service areas. The MSCs perform call handling and mobility management functions. Each MSC is associated with a Visitor Location Register (VLR) (not shown). The VLR is a database that stores information about each wireless device that is active within the MSC service area. This information allows the MSC to process incoming and outgoing calls for each such device. The MSC communicates with the wireless devices over radio links. MSCs may be connected to other MSCs, thereby allowing calls to be routed directly between MSCs. However, not all MSCs are interconnected to each other and calls must be routed over other portions of the telecommunications network or Public Switched Telephone Network (PSTN) 106 to a destination MSC, such as MSC 105. MSC 102 is connected to Service Control Point (SCP) 103 and to PSTN 106 via trunk lines. PSTN 106 can be used to communicate with MSC 105 and with PBX 108.

Messages 11-20 in FIG. 1 illustrate the path of signals through system 10 when called wireless device 107 is active and registered in the network. The calling party dials a code, extension or other alias for the called party on wireless device 101. MSC 102 receives the dialed code 11 from wireless device 101 and transmits the code as message 12 to SCP 103. SCP 103 provides service applications for routing calls through network 10. SCP 103 looks up the profile associated with the Mobile Identity Number (MIN), or the group profile that covers the specific MIN, of wireless device 101 in a database accessible by SCP 103. This database may be part of SCP 103 or it may be at a remote location from SCP 103. In the present invention SCP 103 assumes the characteristics of a MSC. SCP 103 first retrieves the number associated with the called party from the database based on the dialed code. In the preferred embodiment, SCP 103 recognizes this number as corresponding to wireless device 107. SCP 103 locates called wireless device 107 by sending message 13 to Home Location Register (HLR) 104.

HLR 104 is a central repository of profiles that maintains current location and status of wireless devices in its service area. HLR 104 also contains information about the called party, such as directory number, profile information (feature list), current location, serial number, services authorized, and validation period. HLR 104 determines whether called wireless device 107 is reachable. If HLR 104 determines that called wireless device 107 is powered on and registered with the serving network, then it sends a routing information request 14, including an identifier of called device 107, to destination MSC 105 of called wireless device 107. Destination MSC 105 returns a geographic routing number, the Temporary Local Directory Number (TLDN) 15 of called wireless device 107 to HLR 104. The TLDN is a geographic location telephone number which is temporarily assigned by destination MSC 105 to called wireless device 107 for a short period of time to allow this specific call to be completed to it. The TLDN allows a call to the called wireless device to be routed to destination MSC 105 and from there to called wireless device 107.

HLR 104 then sends the TLDN of the called wireless device to SCP 103 via message 16. SCP 103 sends the TLDN to originating MSC 102 associated with calling wireless device 101 via message 17. Thus, in the present invention, SCP 103 communicates with HLR 104 to determine if called wireless device 107 is reachable, before translating the dialed code and returning it to originating MSC 102. Originating MSC 102 then routes the call to destination MSC 105 through PSTN 106 via call setup messages 18 and 19. Destination MSC 105 completes the call to called wireless device 107 using call setup message 20 and the process is complete. Thus, the calling party associated with wireless device 101 had to enter only the code or alias for the called party in order to be connected to him. In an alternative embodiment, SCP 103 looks up the profile of the called party to determine if the calling party has been authorized to make calls to called wireless device 107.

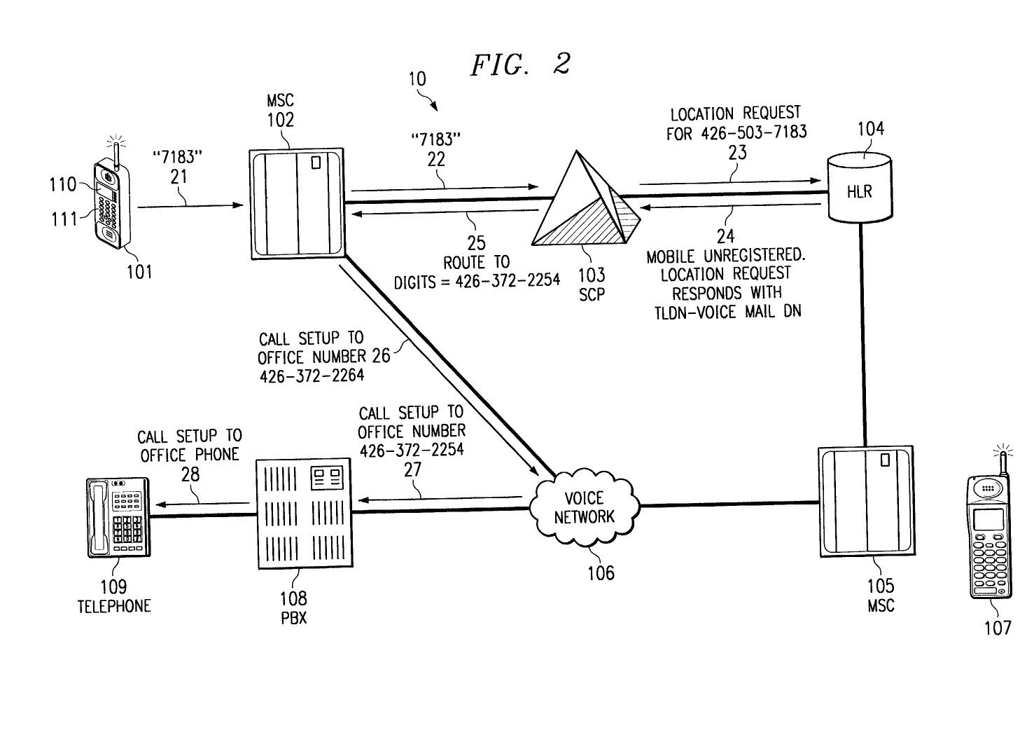

FIG. 2 illustrates the messages 21-28 in network 10 when called wireless device 107 is unreachable, such as when the called wireless device is powered off or is powered on but not registered with the serving device. In this embodiment, the calling party enters the code or alias 21 for the called party on wireless device 101. MSC 102 receives the dialed code from wireless device 101. MSC 102 then transmits the code to SCP 103 via message 22. SCP 103 looks up the profile associated with the MIN of wireless device 101 in a database. If the dialed code or alias is not contained within a list of preselected personal numbers in the profile associated with calling wireless device 101, an error tone is played to device 101 or other default routing is executed. On the other hand, if the dialed code or alias is contained within the list of preselected numbers, SCP 103 retrieves the number for the corresponding called wireless device 107 associated with the called party. SCP 103 sends a location request message 23 to HLR 104. HLR 104 determines if called wireless device 107 is reachable.

If called wireless device 107 is unreachable, i.e. the wireless device is powered off or is powered on but not registered with the serving device, then HLR 104 returns an appropriate message 24, to SCP 103. If desired, SCP 103 could select an alternative number from the database to route the call. SCP 103 would communicate this alternative number to originating MSC 102. If the alternative number is a wireline number or a voice mail number for a wireline phone, originating MSC 102 would then route the call to PBX 108 through PSTN 106. PBX 108 then connects the call to wireline phone 109. Thus, this embodiment of the invention intelligently forwards a call from a wireless network to a wireline network, and also provides abbreviated dialing to the user. The forwarding is dynamic and depends on the state of the called mobile. The translation of the abreviated number to either the mobile or landline telephone depending on the state of the mobile is an improvement over previous art of forwarding when the mobile is called. This method is more efficient by combining the translation and called mobile status check into one operation executed by one system.

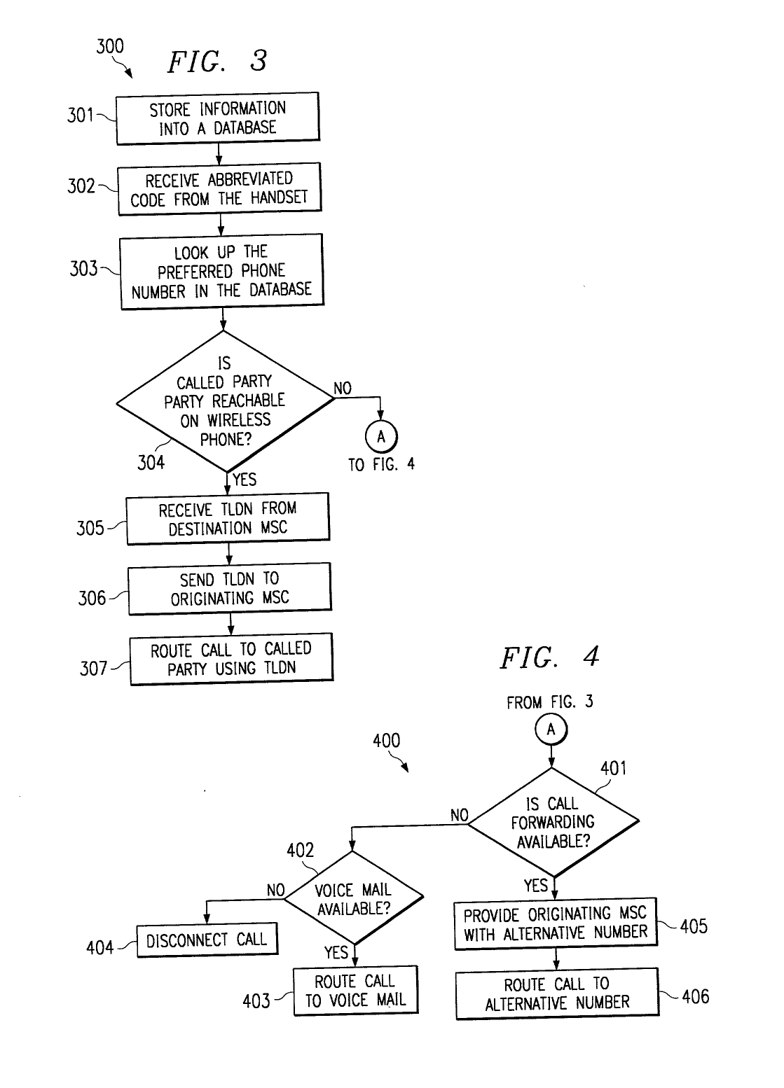

FIG. 3 is a flowchart illustrating the steps followed in a call completion process of an embodiment of the present invention. In step 301, a user stores a plurality of destination telephone profiles in a database. This database may be associated with a SCP, or it may be located at a remote location accessible by the SCP. Each user may have more than one profile and each profile may correspond to more than one communications device for the called party. Furthermore, a user may set-up profiles for each communication device so that only selected users or user groups may communicate with the user on that communication device. The database may be updated by the user through a web site or through a display associated with a communication device or by simply communicating the information by any means to a representative of the service provider.

In step 302, the network receives a code or an alias from a user entered on communication device 101. In step 303, SCP 103 looks up the caller's profile in the database to match the code with a phone number in the profile. If the code does not match with a number, the SCP returns an error message or simply the dialed digits to the serving MSC. If the phone number is for a wireless device, SCP 103 sends the number to HLR 104. In step 304, HLR 104 determines if the called party is reachable at the wireless device. If the called party is not reachable, then call forwarding subprocess of FIG. 4 is initiated. If the called party is reachable, then HLR 104 sends a route request type message to destination MSC 105, which returns a TLDN type number to HLR 104 in step 305. The TLDN is routed to originating MSC 102 in step 306. Originating MSC 102 then completes the call to the called party in step 307.

FIG. 4 is a flowchart illustrating the steps followed to forward a call when a called party is not reachable on the wireless network. If the called party is not reachable at wireless device 107, then in step 401, SCP 103 checks for the alternate number associated with the alias dialed. If such a number is found in its database, SCP 103 returns this number to the MSC 102 to allow the call to be processed. If no alternate number is found, then SCP returns the telephone number of the unreachable mobile to allow normal call handling to take the call. Alternatively, SCP 103 can return to MSC 102 the voice mail number or other alternate number provided by the HLR in step 401.

If call forwarding is available, then HLR 104 provides SCP 103 with an alternative number. SCP 103 may determine the number to be provided to originating MSC 102. This could be the alternative number provided by HLR 104, or it could be a different number based on different parameters within SCP 103. If SCP 103 decides to provide a different number to originating MSC 102, it looks up the profile of the calling party by correlating the MIN of wireless device 101 with a profile contained in the database associated with SCP 103. SCP 103 then retrieves a number for the called party from the profile and in step 405 provides originating MSC 102 with a number for an alternative communication device. If the alternative number is associated with a wireline network, then in step 406, originating MSC 102 routes the call to PBX 108 associated with the wireline number, through PSTN 106. PBX 108 then connects the call to wireline phone 109.

In an alternative embodiment, step 401 also looks up the called party's profile and determines if the calling party has been authorized for call forwarding to a particular device. If the calling party is not eligible to make calls to a particular device then in step 402, HLR 104 determines if the called party associated with called wireless device 107 subscribes to a voice mail service. If the called party subscribes to a voice mail service then in step 403 the call may be routed to the voice mail of the called party. If the called party does not subscribe to a voice mail service, then in step 404 an appropriate message is displayed on display 110 and the call is disconnected. This embodiment allows the called party to screen users eligible to make calls to a particular communication device.

In an alternative embodiment, if call forwarding is available and the calling party does not have an alternative number for the called party in his profile, then the profile of the called party is searched for an alternative number to which the calling party is eligible to connect. The alternative number is then forwarded to the originating MSC 102 in step 405. If the alternative number is associated with a wireline network, then in step 406, originating MSC 102 routes the call to PBX 108 associated with the wireline number, through PSTN 106. PBX 108 then connects the call to wireline phone 109.

The present invention can also be used to complete international calls. When the code or alias of called party 107 is dialed, SCP 103 knowing who the calling party is, who he is trying to call, and where he is currently located, adds the required country, area, and routing codes to complete the call. Moreover, the personal profile system may be configured so that the user can select which portion of the destination telephone number is to be used for abbreviated dialing. Alternatively, the user can select to have a default setting, such as using the last four digits of each stored number.

The advantage of the present invention is that abbreviated dialing can be implemented for forwarding calls from a wireless phone to either another wireless phone or another wireline phone. The invention will complete the call if the called party is available on any of a number of preselected wireless or wireline devices contained in the user profile associated with the called party. Thus, a user can power off the wireless phone when he or she gets to the office. All calls to the wireless phone will then automatically be redirected to the wireline phone in the office.

In the preferred embodiment, calls are forwarded only to numbers of the called party contained in the profile associated with the MIN of the wireless device of the calling party. In an alternative embodiment, calls can be forwarded to any number of the called party contained in the database, irrespective of whether that number is contained in the calling party's profile. In such an embodiment, however, the called party may screen calls automatically by selecting in advance which numbers are to be made available to which users or groups of users. In this embodiment, call screening is provided to complete calls to a particular device only if the calling party is authorized to make calls to that device. For example, if user X is trying to call user Y on device Y1 and device Y1 is not reachable, then the call will be forwarded to device Y2, even if user X's profile does not contain a reference for device Y2. However, if user Y has not authorized user X to call him on device Y2, user X's call will not be forwarded to device Y2. The advantage of this alternative embodiment is the efficient utilization of information in the database, and at the same time assuring the privacy of the called party.

Although the present invention and its advantages have been described in detail, it should be understood that various changes, substitutions and alterations can be made herein without departing from the spirit and scope of the invention as defined by the appended claims.

What is claimed is:

1. A method for routing calls in an integrated wireless and wireline communications system, comprising the steps of:
receiving a code from a calling device;
correlating said received code to a destination device;
querying a locating device to determine if said destination device is reachable, wherein said querying step and said correlating step are performed by the same device; and
completing said call based on information obtained in said querying step.

2. The method of claim 1, further comprising the step of:
storing a plurality of profiles, wherein each of said plurality of profiles is associated with at least one communications device.

3. The method of claim 2, wherein said correlating step comprises the step of:
looking up said received code in a profile associated with an identifier for said calling device.

4. The method of claim 3 wherein said identifier is a Mobile Identification Number (MIN) of said calling device.

5. The method of claim 3 wherein said identifier is an International Mobile Station Identity (IMSI) of said calling device.

6. The method of claim 3 wherein said identifier is an Electronic Serial Number (ESN) of said calling device.

7. The method of claim 1, wherein said calling device is a wireless device.

8. The method of claim 1, wherein said destination device is a wireless device.

9. The method of claim 3, wherein one or more profiles are stored in a database associated with said communications system.

10. The method of claim 9, wherein said database is stored on a network node associated with said communications system.

11. The method of claim 10, wherein said network node is a Service Control Point (SCP).

12. The method of claim 3, wherein each of said plurality of profiles comprises:
a list of codes corresponding to telephone numbers for at least one destination device, wherein said telephone numbers include routing data for said at least one destination device.

13. The method of claim 1, wherein information obtained in said querying step comprises:
routing data for said destination device.

14. The method of claim 10, wherein said querying step comprises the step of:
sending a location request type message to a Home Location Register (HLR) that is accessible by said network node.

15. The method of claim 14, wherein said completing step comprises the substep of:
sending a route request based type message on said location request to a Mobile Switching Center (MSC) associated with said destination device.

16. The method of claim 15, wherein said completing step further comprises the step of:
receiving a Temporary Local Directory Number (TLDN) type number from said MSC associated with said destination device.

17. The method of claim 16, wherein said completing step further comprises the step of:
transferring said TLDN to a MSC associated with said calling device.

18. The method of claim 14, wherein said completing step comprises the step of:
returning a Voice Mail Directory Number (VMDN) to said SCP, if said destination device is not reachable.

19. The method of claim 18, wherein said completing step further comprises the step of:
transferring an alternative number to a Mobile Switching Center (MSC) associated with said calling device.

20. The method of claim 19, wherein said alternative number corresponds to a second destination device selected from a plurality of destination devices.

21. The method of claim 18, wherein said completing step further comprises the step of:
retrieving said alternative number from a second profile.

22. The method of claim 21, wherein said completing step further comprises the step of:
determining whether said calling device has permission to call a destination device associated with said alternative number.

23. The method of claim 22, wherein said completing step further comprises the step of:
transferring said alternative number to a Mobile Switching Center (MSC) associated with said calling device, wherein said MSC associated with said calling device completes said call to said alternative number.

24. The method of claim 22, wherein said completing step further comprises the step of:
sending an error message to said calling device indicating that said destination device is not reachable.

25. A method for routing calls in an integrated wireless and wireline communications system, comprising the steps of:
receiving, at an originating Mobile Switching Center (MSC), a code from a calling device;
correlating at an SCP said received code to a destination device selected from a plurality of destination communications devices;
sending a location request from said SCP to a Home Location Register (HLR) to determine the location of said destination device;
transmitting a routing information request from said HLR to a destination MSC associated with said destination device;
receiving at said HLR a Temporary Local Directory Number (TLDN) of said destination device from said destination MSC;
transmitting said TLDN to said originating MSC; and
routing said call based on said TLDN.

26. The method of claim 25 further comprising the step of:
storing a plurality of profiles in a database associated with said SCP, wherein each of said plurality of profiles is associated with at least one communications devices.

27. The method of claim 26 further comprising the step of:
retrieving information from a profile selected from said plurality of profiles, wherein said profile is associated with said calling device.

28. The method of claim 27 further comprising the step of:
allowing users to configure selected ones of said plurality of profiles.

29. The method of claim 28, wherein said user accesses said profile stored in said database via a computer network.

30. The method of claim 25, wherein said received code is an abbreviated telephone number.

31. The method of claim 30, wherein said completing step comprises the step of:
adding routing codes to said abbreviated telephone number.

32. The method of claim 31, wherein said routing codes are selected from the group consisting of:
country codes;
area codes; and
local exchange codes.

33. The method of claim 32, wherein specific routing codes are added based upon said calling device's location and the location of said destination device.

34. The method of claim 31, wherein specific routing codes are added based upon a user's home service provider and a current roaming service provider.

35. The method of claim 27, wherein said retrieving step comprises the step of:
looking up said received code in said profile associated with a MIN for said calling device to determine said MIN for said destination communications device.

36. The method of claim 35, wherein said retrieving step further comprises the step of:
determining whether said destination device is reachable.

37. The method of claim 36, wherein said determining step comprises the step of:
determining whether said destination device is powered on and registered with a serving network.

38. A method for routing calls in an integrated wireless and wireline telecommunications network, comprising the steps of:
receiving a code from a source telecommunications device, wherein said code corresponds to a destination telephone number stored in a personal profile;
transmitting said code to a database that is coupled to said telecommunications network, wherein said personal profile is stored in said database;
determining whether a destination telecommunications device associated with said destination telephone number is reachable;
retrieving an alternative destination telephone number from said personal profile if said destination telecommunications device is not reachable; and
completing a call under control of said telecommunications network from said source telecommunications device.

39. The method of claim 38, further comprising the steps of:
storing telephone numbers in said personal profile; and
configuring said personal profile.

40. The method of claim 39, wherein a user adds said telephone numbers by entering a preselected code when dialing a telephone number.

41. The method of claim 39, wherein telephone numbers dialed on said source telecommunications device are automatically added to said personal profile.

42. The method of claim 39, wherein a user configures said personal profile via a personal computer that is coupled to said database via a computer network.

43. The method of claim 39, wherein a user configures said personal profile via an Internet web site accessed via a personal computer.

44. The method of claim 39, wherein a user adds said telephone numbers to said personal profile via an Internet web site accessed via a personal computer.

45. A method for routing calls in an integrated wireless and wireline telecommunications network, comprising the steps of:
receiving a code from a source telecommunications device, wherein said code corresponds to a first destination telephone number stored in a personal profile;
transmitting said code to a database coupled to said telecommunications network, wherein said database stores one or more personal profiles;
translating said code to a second destination telephone number based on whether said first destination telephone number is unreachable; and
completing a call under control of said telecommunications network from said source telecommunications device.

46. The method of claim 45, wherein said translating step comprises the step of:
determining whether a first destination telecommunications device associated with said first destination telephone number is reachable.

47. The method of claim 46, wherein said translating step further comprises the step of:
retrieving said second destination telephone number from said personal profile if said first destination telecommunications device is not reachable.

48. A system for routing calls in an integrated wireless and wireline telecommunications network comprising:
means for receiving a code from a calling device, wherein said code corresponds to a destination telephone number, wherein said destination telephone number is stored in a personal profile;
means for transmitting said code to a database that is coupled to said telecommunications network, wherein said personal profile is stored in said database, and wherein said database stores one or more personal profiles;
means for determining whether a destination device associated with said destination telephone number is reachable; and
means for retrieving an alternative destination telephone number from said personal profile if said destination telecommunications device is not reachable.

49. The system of claim 48, further comprising:
means for storing telephone numbers in said personal profile; and
means for configuring said personal profile.

50. The system of claim 49, wherein a user adds said telephone numbers by entering a preselected code when dialing a telephone number.

51. The system of claim 49, wherein telephone numbers dialed on said source telecommunications device are automatically added to said personal profile.

52. The system of claim 49, wherein the means for configuring said personal profile is a personal computer that is coupled to said database via a computer network.

53. The system of claim 49, wherein the means for configuring said personal profile is said source telecommunications device.

54. The system of claim 49, wherein the means for storing said telephone numbers to said personal profile is said source telecommunications device.

55. The system of claim 49, wherein the means for configuring said personal profile is an Internet web site accessed via a personal computer.

56. The system of claim 49, wherein the means for adding said telephone number to said personal profile is an Internet web site accessed via a personal computer.

57. A computer program product having a computer readable medium with computer program logic recorded thereon for use in a system for routing calls in an integrated wireless and wireline telecommunications network, said computer program product comprising:
means for receiving a code from a source telecommunications device, wherein said code corresponds to a destination telephone number stored in a personal profile;
means for transmitting said code to a database that is coupled to said telecommunications network, wherein said personal profile is stored in said database having one or more personal profiles;
means for determining whether a destination telecommunications device associated with said destination telephone number is reachable; and
means for retrieving an alternative destination telephone number from said personal profile if said destination telecommunications device is not reachable.

58. The method of claim 57, further comprising the steps of:
means for storing telephone numbers in said personal profile; and
means for configuring said personal profile.
